(19) United States
(12) Patent Application Publication
(10) Pub. No.: US 2002/0051255 A1
(43) Pub. Date: May 2, 2002

(54) Method and system for point source illumination and detection in digital film processing

(76) Inventors: G. Gregory Mooty, Austin, TX (US); Roland W. Porth, Austin, TX (US); Dung T. Duong, Austin, TX (US)

Correspondence Address: David G. Wille, Baker Botts LLP, 2001 Ross Avenue, Dallas, TX, 75201, US

(21) Appl. No.: 09/746,735

(22) Filed: Dec. 21, 2000

Related U.S. Application Data
(60) Provisional application No. 60/174,049, filed on Dec. 30, 1999.
(60) Provisional application No. 60/173,661, filed on Dec. 30, 1999.

(51) Int. Cl. H04N 1/46

(52) U.S. Cl. 358/509

(57) ABSTRACT

One aspect of the invention is a system for digital film processing. A point light source, such as a laser, directs light onto film coated with a processing solution. Light from the film is measured to produce sensor data that corresponds to the colors in the film. The sensor data is used to construct a digital image corresponding to an image recorded on the film. Another aspect of the invention is a shaped collector that focuses light from the film to a focal point within the shaped collector.

### RELATED APPLICATIONS

This application claims benefit under 35 U.S.C. §119 of the following U.S. provisional patent applications: Serial No. 60/174,049, entitled Method and System for Point Source Illumination for Digital Film Processing, which was filed on Dec. 30, 1999; and Serial No. 60/173,661, entitled Detector Housing for Digital Film Processing, which was filed on Dec. 30, 1999.

### TECHNICAL FIELD OF THE INVENTION

This invention relates generally to the field of electronic film processing and more particularly to a method and system for point source illumination and detection in digital film processing

### BACKGROUND OF THE INVENTION

Digitized images are used extensively in modem society to facilitate the communication of information and ideas through pictures. Print and film photos, documents and the like are often digitized to produce a digital image that can then be viewed, communicated, enhanced, modified, printed or stored. The increasing use of digital images has led to a rising demand for improved systems and methods for film processing and the digitization of film based images into digital images.

Film generally comprises a clear film base and one or more emulsion layers having a photosensitive material, generally silver halide, layered on the clear film base. In the case of color photographic film, the film includes multiple emulsion layers with specific emulsion layers sensitive to different wavelengths of electromagnetic radiation, i.e., light. Conventional color film generally includes a top blue layer, a middle green layer, and a bottom red layer which are photosensitive to blue, green, and red light, respectively. When the film is exposed to light, i.e., taking a picture, the photosensitive material in each emulsion layer reacts to the light in direct proportion to the intensity of light striking the photosensitive material. Accordingly, the various emulsion records the image.

During development, a developer solution is applied to the film. In the case of a silver halide photosensitive material, the developer reacts with the exposed silver halide in each emulsion layer to produce silver grains in each respective emulsion layer. During conventional film processing, dye clouds are formed from the chemical byproduct of the silver grains. When the optimum development time has lapsed, the developer solution is deactivated. A bleach solution is then applied to the film to oxidize the silver grains and produce silver halide. A fix solution is then applied to dissolve the silver halide and the film is rinsed, stabilized and dried, leaving only the dye clouds in each emulsion layer and forming a conventional film negative.

Conventional methods for digitizing film generally involves conventionally developing the film as described above to produce a print or negative. The print or negative is then digitized by a conventional flatbed or film scanner to produce the digital image.

A relatively new process under development is digital film processing. Digital film processing digitizes the film during the development process. Digital film development does not produce an effluent like conventional film processing and also has the capability for producing higher quality digital images than conventional flatbed or film scanners.

In one embodiment of digital film processing, the density of the silver grains in each emulsion layer is measured instead of measuring the density of the dye cloud in the negative. Infrared light from an array of light-emitting diodes (LEDs) is directed through waveguides toward the front and back emulsion layers of the film, as well as being directed through the film. A sensor array, such as a charge-coupled device (CCD), detects the light transmitted through the film and reflected from the front layer and back emulsion layers of the film. The grain densities in the front, middle, and back layers are determined from the measurements and used to compute the color values for each pixel of the film.

The width of the illumination produced by the waveguides often exceeds the width of a line of pixels of the film, exposing the film to more light than required and increasing the possibility of fogging the film. In addition, the light emitted from an LED array may have a broad spectral bandwidth, which may tend to fog the film. Furthermore, the CCD arrays and waveguides can cause the system to be sensitive to film motion perpendicular to the scanned surface of the film. In particular, small movements of the film in an orthogonal direction modulates the energy impinging on the film, which can distort the measurements, resulting in inaccurate measurements and a degraded image.

### SUMMARY OF THE INVENTION

One aspect of the present invention is a digital film processing system for developing and scanning film to produce a digital negative of an image captured on the film. In one embodiment, the digital film processing system comprises a development system, a scanning system, and a data processing system. The developing system operates to coat a processing solution onto the film. The scanning system operates to scan the coated film using at least one point light source and produce sensor data that is communicated to the data processing system. The data processing system then processes the sensor data to produce the digital negative. In the preferred embodiment, the point light source comprises a laser. In one embodiment, at least one frequency of light produced by the point light source is within the infrared region of the electromagnetic spectrum.

Another aspect of the present invention is a scanning system. In one embodiment, the scanning system comprises one or more scanning stations operable to scan a film having a processing solution coated on the film. Each scanning station includes a point light source and a sensor system for the scanning system. The point light source produces light that is focused to a point of light on the coated film. The point of light scans over the coated film. The sensor system measures the light from the coated film. In the preferred embodiment, the point light source comprises a laser. The point light source may also comprise an array of light emitting diodes (LEDs) that are focused using optics, such as a waveguide, lens system, and the like. The scanning system has several important technical advantages. In a particular embodiment, the sensor system includes a shaped collector having a shape that reflects the light to a detector. In the preferred embodiment of the shaped collector, the shaped collector is ellipsoidal. Various embodiments of scanning system may have none, some, or all of these advantages. For example, in some embodiments, the use of the scanning system improves speed with which film can be developed and digitized. In addition, the point light source can be focused to direct light to a minimal number of pixels at a time, which reduces the probability of fogging of the film. Moreover, the point light source may reduce distortions caused by film motion perpendicular to the surface of the film, thus improving the digital image.

Other advantages will be readily apparent to one skilled in the art from the following figures, descriptions, and claims.

### BRIEF DESCRIPTION OF THE DRAWINGS

For a more complete understanding of the present invention and the advantages thereof, reference is now made to the following description taken in conjunction with the accompanying drawings, wherein like reference numerals represent like parts, in which:

FIG. 1 is schematic diagram of a digital film processing system in accordance with the present invention;

FIGS. 2A-2B are schematic diagrams of alternative embodiments of a film processing system in accordance with the present invention;

FIGS. 3A-3B are schematic diagrams of alternative embodiments of a scanning system in accordance with the present invention; and

FIGS. 4A-4C are perspective views of alternative embodiments of a collector in accordance with the present invention;

### DETAILED DESCRIPTION OF THE INVENTION

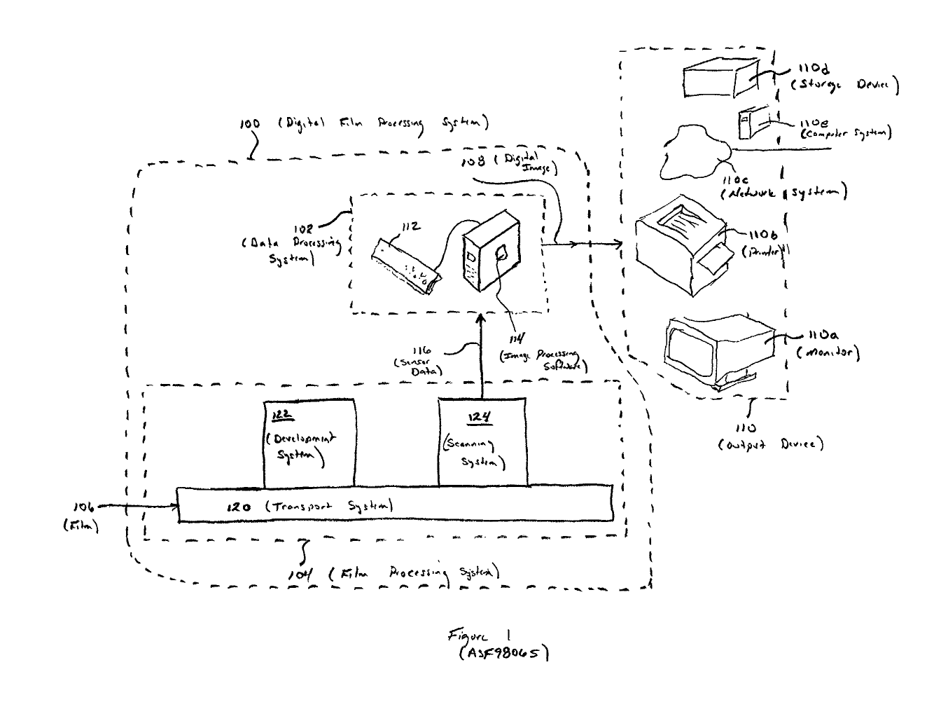

FIGS. 1 through 4 illustrate various aspects and embodiments of a method and system for point source illumination and detection in digital film processing. As described in greater detail below, one aspect of the present invention is a point light source, such as a laser, used to illuminate coated film in a digital film processing system. Another aspect of the present invention is a collector sensor system operable to collect and measure light from the coated film.

FIG. 1 is a schematic diagram of a digital film processing system 100 in accordance with one embodiment of the present invention. In the embodiment illustrated, digital film processing system 100 comprises a data processing system 102 and a film processing system 104 operable to digitize a film 106 to produce a digital image 108 that can be output to an output device 110. Film, as used herein, includes color, black and white, x-ray, infrared, or any other type of film and is not meant to refer to any specific type of film or a specific manufacturer.

Data processing system 102 comprises any type of computer or processor operable to process data. For example, data processing system 102 may comprise a personal computer manufactured by Apple Computing, Inc. of Cupertino, Calif. or International Business Machines of New York. Data processing system 102 may also comprise any number of computers or individual processors, such as an array of processing boards using application specific integrated circuits (ASICs).

Data processing system 102 may include an input device 112 operable to allow a user to input information into the digital film processing system 100. Although input device 112 is illustrated as a keyboard, input device 112 may comprise any input device, such as a touch pad display, keypad, mouse, point-of-sale device, voice recognition system, memory reading device such as a flash card reader, or any other suitable data input device.

Data processing system 102 includes image processing software 114 resident on the data processing system 102. Film processing system 102 receives sensor data 116 from film processing system 104. As described in greater detail below, sensor data 116 is representative of the colors in the film 106 at each discrete location, or pixel, of the film 106. The sensor data 116 is processed by image processing software 114 to produce the digital image 108. The digital image 108 is then communicated to one or more output devices 110.

Output device 110 may comprise any type or combination of suitable devices for displaying, storing, printing, transmitting or otherwise outputting the digital image 108. For example, as illustrated, output device 110 may comprise a monitor 110a, a printer 110b, a network system 110c, a mass storage device 110d, a computer system 110e, or any other suitable output device. Network system 110c may be any network system, such as the Internet, a local area network, and the like. Mass storage device 110d may be a magnetic or optical storage device, such as a floppy drive, hard drive, removable hard drive, optical drive, CD-ROM drive, and the like.

As described in greater detail below, film processing system 104 operates to electronically scan the film 106 using light from a point light source, such as a laser, to produce the sensor data 116. As illustrated, film processing system 104 comprises a transport system 120, a development system 122, and a scanning system 124. Although the film processing system 104 is illustrated with a development system 122, alternative embodiments of the digital film processing system 104 do not require the development system 122. For example, film 106 may have been preprocessed and not require processing as described below.

Transport system 120 operates to dispense and move the film 106 through the digital film processing system 100. In a preferred embodiment, the transport system 120 comprises a leader transport system in which a leader is spliced to the film 106 and a series of rollers pulls the film 106 through the film processing system 104, with care taken that the image surface of the film 106 is not contacted. Similar transport systems 120 are found in film products manufactured by, for example, Noritsu Koki Co. of Wakayama, Japan, and are available to those in the art.

As described in detail below, the development system 122 applies a processing solution to the film 106. The processing solution applied to the film 106 may include any number of photographic processing solutions. In the preferred embodiment, the processing solution includes a developer solution that initiates development of the photosensitive materials in the film 106. In a particular embodiment, the developer solution comprises a viscous black and white developer solution, whose developer chemistry is similar to HC-110 marketed by Kodak, Inc., of Rochester, N.Y. In this embodiment, the black and white developer solution only develops the grains of photosensitive material and not the dye clouds in the film 106. In another embodiment, the developer solution comprises a viscous color developer solution, whose chemistry is similar to those available by Kodak, Inc. In this embodiment, the dye clouds and grains of photosensitive material are developed in the film 106. Additional applicators may be used to apply additional processing solution to the film 106. For example, the additional processing solutions may comprise stop solutions, inhibitors, accelerators, bleach solutions, fix solutions, and the like.

As described in greater detail below, the scanning system 124 includes a point light source and a sensor system that operates to scan the film 106 and produce sensor data 116. The point light source illuminates the film 106 at an illumination point on the film 106. In the preferred embodiment, the illumination point is the size of a pixel or smaller. The point light source minimizes the effects of the film 106 moving orthoganally to the path of the film 106. The interaction between the illumination and the film 106 is measured by the sensor system. Based on the interaction, the sensor system produces sensor data 116 that is communicated to the data processing system 102.

In one embodiment of the scanning system 124, the point light source illuminates silver grains in the film 106. Color at each pixel location is correlated to the density of silver grains in each respective layer at each pixel. In this embodiment, the processing solution generally comprises a black and white developer for initiating development of the silver grains within the film 106.

In another embodiment, the point light source illuminates silver and dye clouds in the film 106. In this embodiment, the point light source will generally comprises multiple light sources that produce different frequencies of light that interact with the different dye clouds. Color at each pixel is directly correlated to the dye cloud densities in the film 106. In this embodiment, the processing solution comprises a color developer for initiating development of the dye clouds within the film 106.

In yet another embodiment, the point source illuminator illuminates both the silver grains and the dye clouds. In this embodiment, the interaction of the light with the dye clouds and the silver grains may produce higher resolution data that can be used to construct the digital image 108. Color at each pixel can be correlated from the silver grain data and the dye cloud data within the film 106. In this embodiment, the processing solution comprises a color developer.

In operation, exposed, but undeveloped film 106 is fed into the transport system 120. The film 106 is transported through the development system 122. The development system 122 applies a processing solution to the film 106 that develops the film 106. The transport system 120 moves the film 106 through the scanning system 124. As described in detail below, the scanning system 124 scans the film 106 using a point light source. Light from the film 106 is measured by the sensor system, which produces sensor data 116. The sensor data 116 represents the colors in the film 106 at each pixel. The sensor data 116 is communicated to data processing system 102. The data processing system 102 processes the sensor data 116 using image processing software 114 to produce the digital image 108. The data processing system 102 may also operate to enhance of otherwise modify the digital image 108. The data processing system 102 communicates the digital image 108 to the output device 110 for viewing, storage, printing, communicating, or any combination of the above.

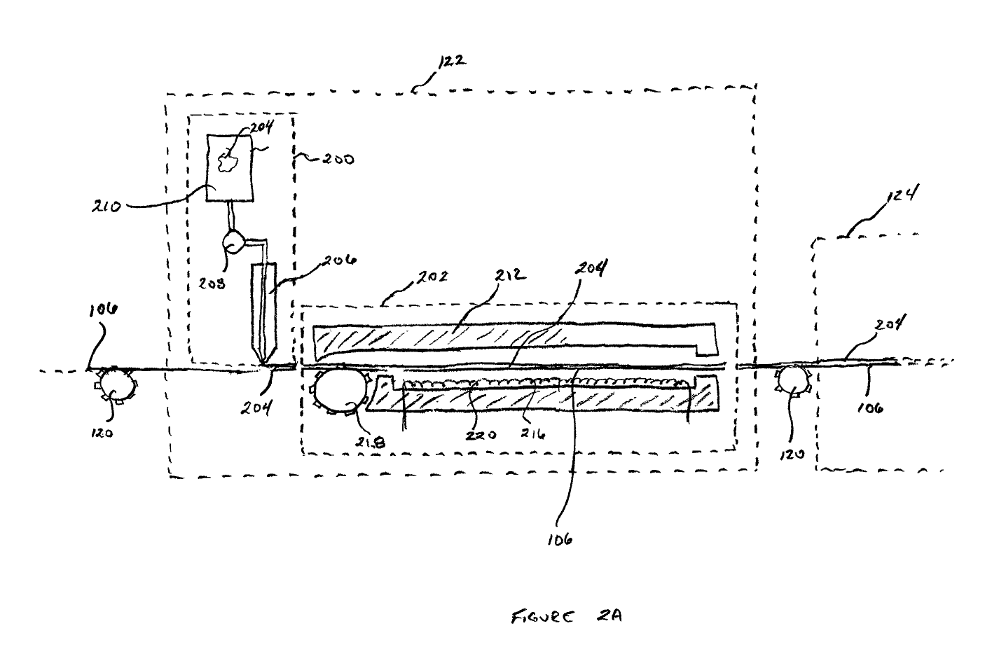

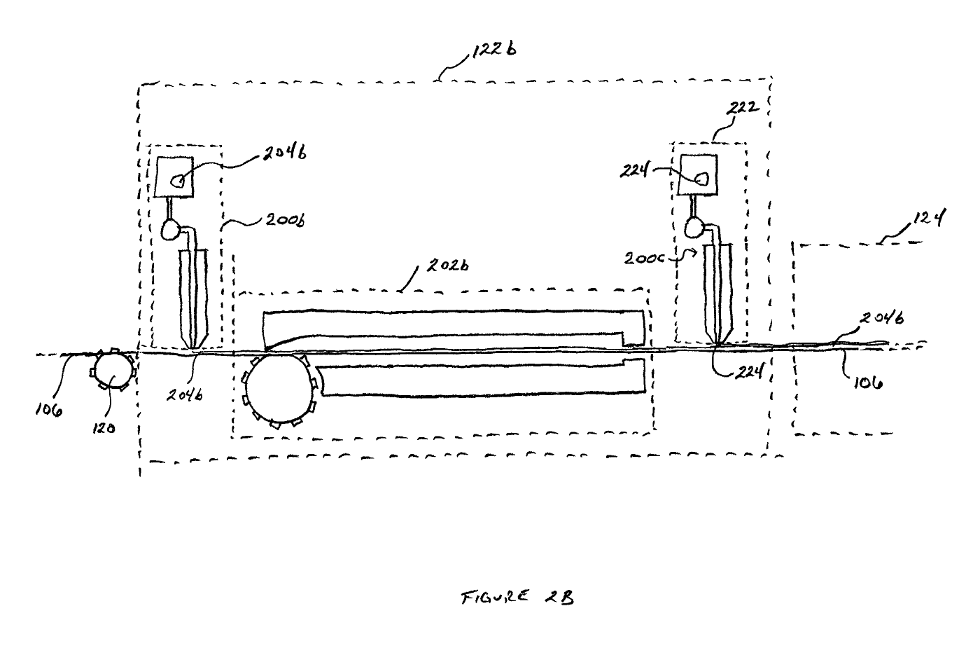

FIG. 2A illustrates a development system 122a in accordance with one embodiment of the present invention. In this embodiment, development system 122a comprises an applicator station 200 and a developer station 202. The applicator station 200 operates to apply a relatively uniform coating of a processing solution 204 to the film 106. In the preferred embodiment, the applicator station 200 comprises an applicator 206, a fluid delivery system 208, and a reservoir 210.

The applicator 206 operates to coat the film 106 with the processing solution 204. In the preferred embodiment, the applicator 206 comprises a slot coater device, as illustrated. In alternative embodiments, the applicator 206 comprises an ink jet applicator, a tank, an aerosol applicator, drip applicator, or any other suitable device for applying the processing solution 204 to the film 106.

The fluid delivery system 208 delivers the processing solution 204 from the reservoir 210 to the applicator 206. In an embodiment in which the applicator 206 comprises a slot coater device, the fluid delivery system 208 generally delivers the processing solution 204 at a constant volumetric flow rate to help insure uniformity of coating of processing solution 204 on the film 106.

The developer station 202 operates to give the film 106 time to develop prior to being scanned by the scanning system 124. In the embodiment illustrated, the developer station 202 forms that portion of the transport system 120 between the applicator 206 and the scanning system 124. As illustrated, the developer station 202 includes a cover 212 that protects the film 106 during development. The length of the developer station 202 is generally dependent upon the development time of the film 106. In particular, depending upon the environment and chemical nature of the processing solution 204, development of the film 106 may require as little as a few seconds to as long as several minutes.

In operation, transport system 120 transports the film 106 through the applicator station 200. The applicator station 200 applies the processing solution 204 to the film 106. The processing solution 204 initiates development of the film 106. In some embodiment, the processing solution 204 comprises a black and white developer solution. In these embodiments, the silver grains are developed in the film 106. In other embodiment, the processing solution 204 comprises a color developer solution. In these embodiments, the silver grains and the color dyes are developed in the film 106. The transport system 120 moves the film 106 through the space forming the developer station 202. As discussed above, the developer station 202 allows the film 106 time to develop. After development, the film 106 is transported by the transport system 120 to the scanning system 124.

FIG. 2B illustrates an alternative development system 122b in accordance with the present invention. In this embodiment, the development system 122b comprises an applicator station 200b, a developer station 202b, and a halt station 220. The applicator station 200b applies processing solution 204 to the film 106. In the preferred embodiment, the processing solution 204 comprises a developer photographic solution that initiates development of the film 106. Developer station 202b forms that portion of the transport system 120 between the applicator station 200b and the halt station 220.

Halt station 220 operates to inhibit the continued development of the film 106. In the embodiment illustrated, halt station 220 comprises an applicator station 200c similar to the applicator station 200. In this embodiment, applicator station 200c applies a halt solution 224 to the developing film 106. Halt solution 224 may comprise a bleach solution, a fix solution, a blix solution, a stop solution, a stabalizer solution or any other suitable solution for slowing the development of the film 106.

In yet another embodiment of the development system 122b, the halt station 220 comprises a chiller (not expressly shown) that operates to cool the coated film 106. Cooling the coated film 106 substantially stops the development action of the film 106. Halt station 220 may comprise other suitable systems for substantially stopping the continued development of the film 106. For example, the halt station 220 may comprise a dryer that dries the film 106 to inhibit further development of the film 106. The halt station 220 may also comprise any suitable combination of the above. For example, the halt station 220 may comprise an applicator for applying a halt solution, a chiller, and a dryer.

In general, the processing solution applied to the film 106 is not removed, but remains on the film 106 as the film 106 is transported through the scanning system 124. The processing solution is absorbed into the film 106 and dries on the film 106, thereby eliminating excess chemicals or effluents that require disposal. In contrast, conventional film development systems immerse and agitate the film in a series of baths. As the chemical solutions become contaminated with other chemicals and silver, the chemical solutions require disposal. These chemical solutions are generally considered hazardous materials and must be disposed of in accordance with strict government regulations, increasing the cost of film processing and harming the environment.

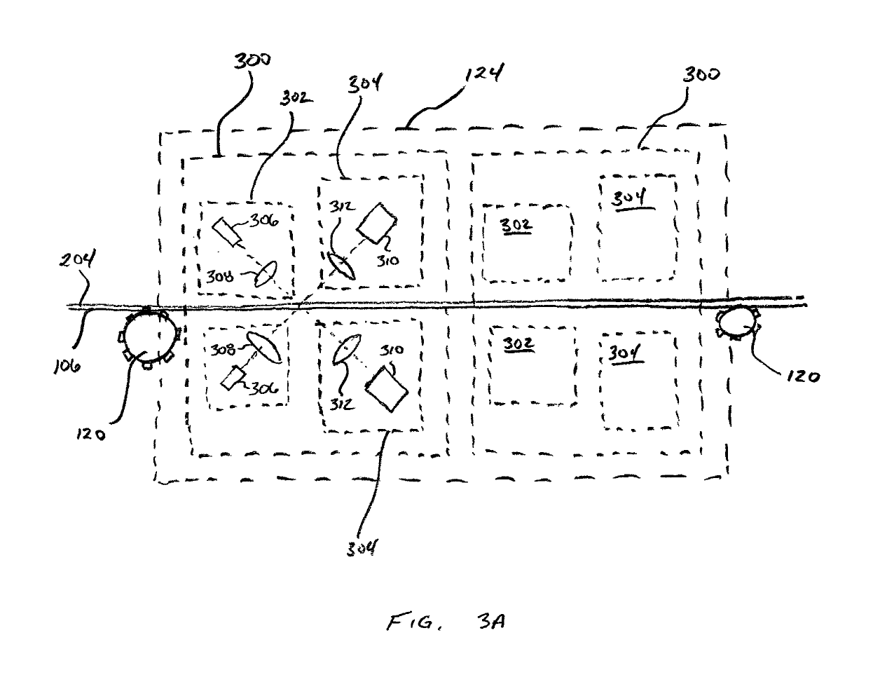

FIG. 3A is a diagram of the scanning system 124. The scanning system 124 comprises one or more scanning stations 300. Each scanning station 300 comprises at least one point light source 302 and at least one sensor system 304. The point light source 302 includes one or more light sources 306 and optional optics 308. The sensor system 304 includes one or more detectors 310 and optional collector 312. In operation, the point light source 302 produce one or more beams of light 320 that form a point of light 322 on the film 106. The sensor system 304 operates to measure the light 320 from the film 106 and produce sensor data 116 that is communicated to the to the data processing system 102.

Individual scanning stations 300 may have different architectures. For example, light 320 sensed by the sensor system 304 may be transmitted light or reflected light. Light 320 reflected from the film 106 is generally representative of the emulsion layer on the same side as the sensor system 304. Specifically, light 320 reflected from the front-side of the film 106 typically represents the blue sensitive layer and light 320 reflected from the back-side of the film 106 typically represents the red sensitive layer. Light 320 transmitted through the film 106 collects information from all layers of the film 106. Individual scanning stations 300 may also use different colors, or frequency bands, and color combinations for scanning the film 106. In particular, different colors of light interact differently with the film 106. Visible light interacts with the dye clouds and silver within the film 106. Whereas, infrared light interacts with the silver, but the dye clouds are generally transparent to infrared light. The term “color” is used to generally describe specific frequency bands of electromagnetic radiation, including visible and non-visible light.

Visible light, as used herein, means electromagnetic radiation having a frequency or frequency band generally within the electromagnetic spectrum of near infrared energy (Wavelength of near infrared >700 nm ) to near ultraviolet light (Wavelength of ultraviolet light_{—}<400 nm ). Visible light can be separated into specific bandwidths. For example, the color red is generally associated with light within a frequency band of 600 nm to 700 nm , the color green is generally associated with light within a frequency band of 500 nm to 600 nm , and the color blue is generally associated with light within a frequency band of 400 nm to 500 nm . Near infrared energy is associated with radiation within a frequency band of approximately 700 nm to 1500 nm . Although specific colors are described herein, the scanning station 300 may utilize other suitable colors and frequency ranges without departing from the spirit and scope of the invention. The wavelength ranges provided herein are for illustration and are not meant to be exact. In addition, although specific colors are described herein, the scanning station 300 may utilize other suitable colors and frequency ranges without departing from the spirit and scope of the invention.

The light source 306 may comprise one or more devices or system that produces suitable point of light 322. In one embodiment, the light source 306 produces near infrared light within a wavelength of approximately 750 nm to 2 microns. In particular, a wavelength of approximately 830 nm has been determined to be preferable. In this embodiment, the near infrared light 320 scans the silver within the film 106, but does not detect dye clouds, if any, within the film 106. In addition, because conventional film 106 is not generally sensitized to near infrared light, scanning the film 106 with near infrared light 320 will not substantially fog the film 106. As a result, the film 106 can be scanned a number of times during the development period, as described in greater detail below.

In another embodiment, the light source 306 produces light 320 within the visible light spectrum. For example, blue light can be used to perform a reflectance scan of the blue layer of the film 106. In this example, blue light 320 will detect both the silver in the blue layer of the film 106 and, when color developer is used, the yellow dye cloud in the film 106. Red light 320 could be used to perform a transmissive scan of the film 106. In this example, red light 320 will detect the silver in each layer of the film 106 and also the cyan dye cloud. In another example, white light is used to perform a transmissive scan of the film 106. In this example, the white light 320 will detect each dye cloud within the film 106, as well as the silver in each layer of the film 106. Other suitable colors and combinations of light 320 may be used for scanning the film 106 without departing from the scope of the invention.

The light source 306 is preferably a laser. The collimated light produced by a laser reduces problems associated with film motion perpendicular to the surface of the film 106. Specific types of lasers produce different colors of light 320. For example, a gallium arsenide or an indium gallium phosphide laser may be used to produce infrared light. In another embodiment, the light source 306 comprises a light source that produces non-collimated light that is focused into a point of light 322 using optional optics 308. In this embodiment, the light source may comprise one or more light emitting diodes (LEDs), a broad spectrum light source, such as a fluorescent, incandescent, halogen, direct gas discharge lamps, and the like. Filters, such as a color wheel, or other suitable wavelength modifiers or limiters maybe used to provide the specified color or colors of light 320.

Optional optics 308 for the point light source 302 directs the light 320 to the film 106. In an embodiment wherein the light source 306 comprises a laser, the optics 308 generally comprises one or more mirrors operable to direct the light 320 onto the film 106. In an embodiment using a non-collimated light source, the optics 308 includes a lens system for focusing the light 320 into a point of light 322. The optics 308 may also include one or more polarizing lenses for polarizing the light 320. The optics 308 may comprise other suitable devices for focusing light 320 from the light source 306.

The size of the point of light 322 on the film 106 is preferably the approximate size of a pixel (˜12 microns). A different size of the point of light 322 may be used to produce a different pixel size. In addition, light 322 can be scanned in different spaced intervals to derive a smaller pixel size. For example, in the case of a 12 micron point of light 322, the point of light 322 can be scanned across the film 106 in increments of 6 microns and the scanning interval can be decreased to derive a small pixel size. Individual light sources 306 may be alternately or simultaneously illuminated, or may have different frequencies.

The detector 310 comprises one or more photodetectors that convert light 320 from the film 106 into data signals 116. In the preferred embodiment, the detector 310 comprises a charge coupled device (CCD). The detector 310 may also comprise a photodiode, phototransistor, photoresistor, and the like. Detector 310 may be sampled at a rate sufficient to provide data for each pixel illuminated or for some subset of all pixels. The use of a single photodiode is more economical than the use of a linear CCD array required in systems that illuminate film one line at a time. The detector 310 may include filters to limit the bandwidth, or color, detected by individual photodetectors.

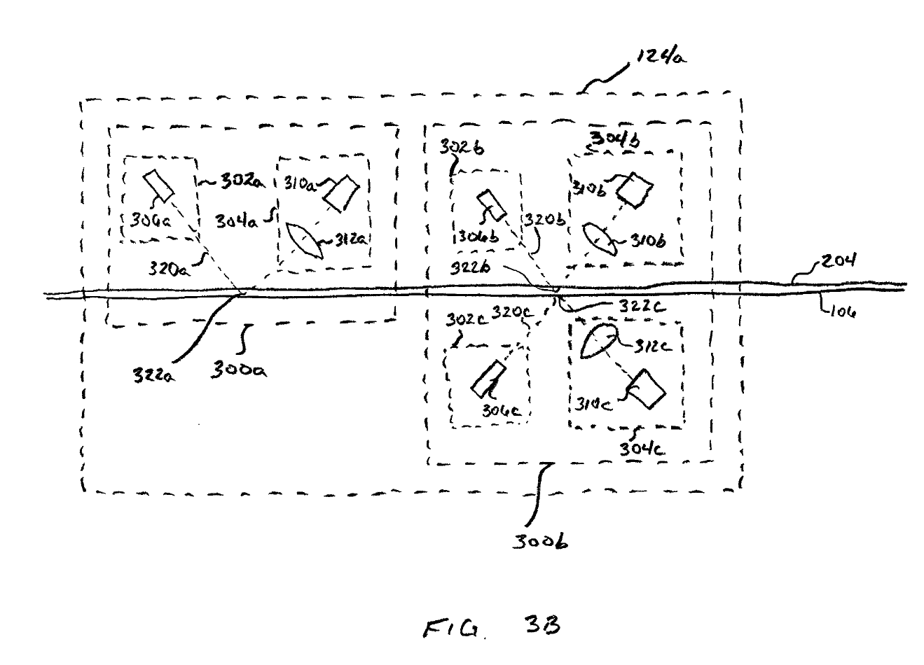

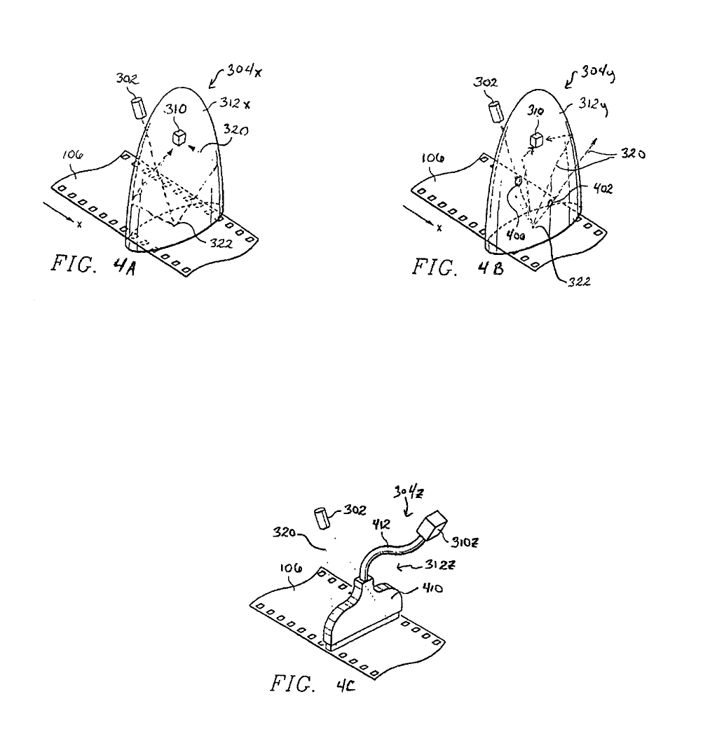

Collector 312 directs the light 320 from the film 106 onto the detector 310. The preferred embodiments of collector 312 are illustrated in FIGS. 4A-4C. In other embodiments, the collector 312 comprises a lens system that directs the light 320 from the film 106 onto the detector 310. In a particular embodiment, the optics 312 includes at least one polarizing lens.

FIG. 3B is a schematic diagram illustrating a scanning system 124a in accordance with one embodiment of the present invention. The scanning system 124a is illustrated with a first scanning station 300a and a second scanning station 300b. The first scanning station 300a comprises a first point light source 302a and a first a first sensor system 304a located on the front side of the film 106. In this embodiment, the first point light source 302a preferably produces infrared light 320a that is focused in a point of light 322a on the film 106.

In operation, the transport system 120 moves the film 106 through the scanning station 300a. The focused light 320a scans the film 106. The infrared light 320a interacts with the silver, but not the dye cloud, in the top layer of the film 106. The first sensor system 304a detects the light 320a reflected from the film 106 and produces sensor data 116 that is communicated to the data processing system 102. The sensor data 116 represents the density of silver within the front, or blue, layer of the film 106. Based on the density of silver, the intensity of blue can be calculated.

The second scanning station 300b comprises a second point light source 302b and a second sensor system 304b, and a third point light source 302c and a third sensor system 304c located on the opposite, or back, side of the film 106. In a particular embodiment, the second point light source 302b produces blue light 320b, and the third point light source 302c produces infrared and visible light 320c.

In operation, the point light source 302b focuses the blue light 320b in a point of light 322b on the front side of the film 106. Similarly, the point light source 302c focuses a visible and infrared light 320c in a point of light 322c on the backside of the film 106. Each point of light 322b and 322c is scanned across the respective side of the film 106.

The sensor system 304b detects blue light 320b reflected from the front of the film 106 and also visible and infrared light 320c transmitted through the film 106. In this embodiment, because film 106 generally has a yellow filter below the blue emulsion layer, the blue light 320b will not be transmitted through the yellow filter. The sensor system 304c detects infrared and visible light 320b reflected from the back of the film 106. The blue light 320b interacts with the silver and dye cloud within the blue emulsion layer of the film 106 and is measured by the sensor system 304b, yielding the front signal. Some of the visible and infrared light 320c is transmitted through film 106 and is measured by the sensor system 304b, yielding multiple through signals. Some of the visible and infrared light 320c is also reflected from the back (red) layer and is measured by sensor system 304c, yielding multiple back signals. The data values for the front, back and through signals are determined for each pixel and represent the sensor data 116 communicated to the data processing system 102. The signal values represent the density of silver and dye clouds in each color layer of the film 106. Based on the density of the silver and dye clouds in each color layer of the film 106 of each pixel, the data processing system 102 can derive the colors representing the image recorded on the film 106 and create the digital image 108.

The sensor system 304b measures reflective blue light 320b and transmitted visible and infrared light 320c, including different frequencies of light 320c. Likewise, the sensor system 304c measures reflected light 320c, including different frequencies of light 320c. Multiple methods can be used to distinguish the signal associated with transmitted and reflected light 320 and different frequencies associated with the transmitted and reflected light 320. In one embodiment, the respective point light sources 302 are alternatively turned on-and-off to prevent the sensor system 304 from collecting multiple readings simultaneously. In addition, point light source 302c can individually pulse different frequencies of light 320c. In this manner, only a single point light source 302 at a known frequency is operating at any one time. In another embodiment, the point light sources 302 produce distinct frequencies of light 320 that can be discerned by the sensor systems 304. In this embodiment, each sensor system 304 includes a filter (not expressly shown) that separates the light 320 or sensor data 116 into the respective signals. In yet another embodiment, amplitude modulation may be used to increase the signal-to-noise ratio in a manner analogous to the process of embedding an audio sound wave onto a carrier frequency as used in AM radio broadcast. An oscillator (not explicitly shown) may be used to modulate the light from point light source 302. The frequency of modulation may be higher than the pixel sample frequency at the detector 310. A filter (not expressly shown), such as a narrow band pass filter, may be used to isolate the signal on the carrier frequency received by sensor system 304 from noise that occurs outside of the carrier frequency.

Although two scanning stations 300 have been described, the scanning system 124 may also additional scanning stations 300 for scanning the film 106 at multiple development times. In one embodiment, three scanning stations 300 are used to scan the film 106 at an underdeveloped, fully developed, and overdeveloped time. As the film 106 is developed, the film 106 generates different types of sensor data 116. In particular, a first scanning station 300 scans the film 106 when the development time is shorter than the fully developed period. At this time, the film 106 shows image highlights that are saturated when the film 106 is fully developed. A second scanning station (not expressly shown) scans the film 106 when the film 106 is fully developed. At this time, the majority of the image detail is clear, but there remains image detail that is lost in the highlights and the shadows. A third scanning station (not expressly shown) scans the film 106 when the film 106 is over developed. At this time, the image detail within the shadows is clear, but large portion of the image data is saturated and over-exposed. Using the sensor data 116 at each of these development times, a digital image 108 can be produced that includes a larger dynamic range than could otherwise be produced by scanning a conventional negative.

The reflected light 320 detected by the respective sensor system 304 may include specular reflection. Specular reflection is that portion of the reflected light 320 that reflects off the surface of the film 106 without penetrating into the film 106. Specular reflection does not contain any image data recorded in the film 106 and forms noise that can interfere with the image data. In one embodiment to reduce specular reflection, the light 320 is polarized or conditioned to produce polarized light 320. Light that reflects off of film 106 in a purely specular manner undergoes a known change in polarization, but light that interacts with silver within the film 106 undergoes random changes in polarization. By including a polarizing filter as part of the sensor system 304, light 320 having the polarization of the specularly reflected light can be blocked, while light 320 reflected by silver within the film 106 can pass through the polarizing filter to the detector 310. In this manner, specularly reflected light 320 may be greatly reduced, improving the quality of the light 320 received at sensor system 304.

FIG. 4A illustrates a housing sensor system 304x in accordance with one embodiment of the present invention. In this embodiment, the shaped sensor system 304x comprises a shaped collector 312x and a detector 310x. Also illustrated is film 106 moving in the x-direction and point light source 302. Point light source 302 and film 106 are as discussed previously. Shaped collector 312x operates to capture and focus light 320 through the use of geometry. In one embodiment, shaped collector 312x is formed generally in the shape of an ellipsoid. One property of an ellipsoid is that light can be collected to a focal point. By locating the detector 310x at one of the focal points, the majority of the light 320 reflected from the other film 106 is focused on the detector 310x. As the point of light 322 is scanned across the film 106, the signal may be adjusted to compensate for the focal strength of the light 320. In this embodiment, the detector 310 generally comprises a single element detector such as a photodiode, but could be any type of suitable photodetector. Although the shaped collector 312x is illustrated as an ellipsoid, the shaped collector 312x may be any suitable shape for collecting and focusing light 320 from the film 106 onto the detector 310x.

In one embodiment, shaped collector 312x has an inside surface with a highly optically reflective coating such as polished metal. In this embodiment, the shaped collector 312x will generally reflect the light 320 to a distinct focal point within the shaped collector 312x. In another embodiment, the shaped collector 312x has an inside surface having a diffusely reflective coating such as barium sulfate. In this embodiment, light 320 will be reflected inside shaped collector 312x, but not to a single focal point. Therefore, the detector 310x may be located substantially anywhere inside the diffusely coated shaped collector 312x.

FIG. 4b illustrates a shaped sensor system 304y in accordance with another embodiment of the present invention. In this embodiment, shaped sensor system 304y includes detector 310y and a shaped collector 312y. Detector 310y is similar to detector 310, and shaped collector 312y is similar to shaped collector 312x described above, with the exception that shaped collector 312y includes a window 400 and a trap 402. Shaped collector 312y is designed to reduce specular reflection. As illustrated, light 320 from point light source 302 enters the shaped collector 312y through window 400 and is reflected from film 106. Specular reflection of light 320 from the film 106 and captured by trap 402. Reflection of the light 320 from the silver within the film 106 is captured within the shaped collector 312y and directed to the detector 310y. The trap 402 may be a physical opening in shaped collector 312y, a trap to capture specular reflection, or any suitable construct able to separate out specular reflection. The location of the trap 402 may be experimentally or analytically determined. For example, light 320 reflected from the surface of film 106 as specular reflection is reflected at approximately the same angle as the angle of incidence on the film 106. To reduce specular reflection, trap 402 may be placed to trap specular light 320 reflected at approximately the same angle as the angle of incidence.

FIG. 4C illustrates an optic fiber sensor system 304z. In this embodiment, the fiber optic sensor system 304z comprises an optic fiber collector 312z and a detector 310z. Illustrated is the point light source 302 and film 106, as well as the optic fiber sensor system 304z. The optic fiber collector 312z includes an optic fiber sensor 410 and an optic fiber cable 412 with a detector 310z operably attached to the optic fiber cable 412 opposite the optic fiber sensor 410. In operation, point light source 302 scans film 106 with light 320. Reflected light 320 is gathered by optic fiber sensor 410 and transmitted through optic fiber bundle 412 to detector 310z. In the embodiment illustrated, optic fiber sensor 410 is arranged as a linear array of optical fibers. In one embodiment, to reduce specular reflection, point light source 302 is located to ensure specular reflection occurs at an angle that substantially avoids the optic fiber sensor 410. Additionally, polarized light may be used to eliminate specular reflection as described in conjunction with FIG. 3.

While the invention has been particularly shown and described in the foregoing detailed description, it will be understood by those skilled in the art that various other changes in form and detail may be made without departing from the spirit and scope of the invention.

What is claimed is:

1. A scanning station for scanning film having a coating of processing solution, comprising:
at least one point light source operable to produce light that is focused into a point of light onto the film; and
at least one sensor system operable to measure light from the film.

2. The scanning station of claim 1, wherein at least one point light source comprises a laser.

3. The scanning station of claim 2, wherein the laser comprises a near infrared laser.

4. The scanning station of claim 1, wherein the point light source produces visible light.

5. The scanning station of claim 4, wherein the point light source produces blue light.

6. The scanning station of claim 1, wherein the point light source produces infrared light.

7. The scanning station of claim 1, wherein the point light source produces polarized light and the sensor system includes a polarizing filter.

8. The scanning station of claim 1, wherein the sensor system comprises a detector and a collector.

9. The scanning station of claim 8, wherein the collector comprises a shaped collector having a substantially ellipsoid shape.

10. The scanning station of claim 9, wherein the shaped collector includes a window and a trap.

11. The scanning station of claim 1, wherein the at least one point light source comprises a first point light source operable to illuminate a first side of the film, and a second point light source operable to illuminate a second side of the film.

12. The scanning station of claim 11, wherein the first point light source is operable to emit light within a first frequency band, and the second point light source is operable to emit light within a second frequency band.

13. The scanning station of claim 1, wherein the point light source includes an oscillator operable to produce modulated light, and the sensor system includes a filter operable to isolate the modulation signal.

14. A digital film processing system for developing and scanning film to produce a digital negative of an image captured on the film, the system comprising:
a development system operable to coat a processing solution on the film;
a scanning system operable to scan the coated film using at least one point light source and produce sensor data; and
a data processing system operable to receive the sensor data and calculate the digital negative.

15. The digital film processing system of claim 14, wherein the development system includes at least one slot coater applicator.

16. The digital film processing system of claim 14, wherein the development system includes a halt station.

17. The digital film processing system of claim 14, wherein the processing solution comprises a developer.

18. The digital film processing system of claim 14, wherein at least one of the point light sources comprises a laser.

19. The digital film processing system of claim 18, wherein the laser comprises a near infrared laser.

20. The digital film processing system of claim 14, wherein at least one point light sources produces visible light.

21. The digital film processing system of claim 14, wherein at least one of the point light sources produces polarized light and a sensor system includes a polarizing filter.

22. The digital film processing system of claim 14, wherein the scanning system includes a sensor system having a detector and a collector.

23. The digital film processing system of claim 22, wherein the collector comprises a shaped collector having a substantially ellipsoid shape.

24. A method for digitizing an image on a film coated with a processing solution, the method comprising:
illuminating the coated film with light from at least one point light source;
measuring the light from the coated film and producing sensor data; and
processing the sensor data to produce a digital image

25. The method of claim 24, wherein the light includes infrared light.

26. The method of claim 24, wherein the light includes red light, blue light, and infrared light.

27. The method of claim 24, wherein measuring the light comprises focusing the light from the coated film using a shaped collector onto a detector that produces sensor data in response to the intensity of light impinging the detector.

28. The method of claim 24, further comprising coating the processing solution to the film.

29. The method of claim 28, wherein the processing solution is coated on the film using a slot coater applicator.

30. The method of claim 24, wherein the processing solution comprises a developer.
